(19) United States
(12) Patent Application Publication
(10) Pub. No.: US 2017/0253216 A1
(43) Pub. Date: Sep. 7, 2017

(54) VEHICLE CONTROL SYSTEM

(71) Applicants: Tetsuo Nishidai, Aichi (JP); Naoyuki Ishihara, Aichi (JP); Yosuke Tomita, Aichi (JP)

(72) Inventors: Tetsuo Nishidai, Aichi (JP); Naoyuki Ishihara, Aichi (JP); Yosuke Tomita, Aichi (JP)

(73) Assignee: OMRON AUTOMOTIVE ELECTRONICS CO., LTD., Aichi (JP)

(21) Appl. No.: 15/448,828

(22) Filed: Mar. 3, 2017

(30) Foreign Application Priority Data
Mar. 4, 2016 (JP) 2016-041942

(51) Int. Cl. B60R 25/24; H04M 1/725; B60R 25/01; G07C 9/00

(52) U.S. Cl. CPC B60R 25/241; G07C 9/00119; G07C 9/00309; H04M 1/7253; B60R 25/01; G07C 2009/00404

(57) ABSTRACT

A vehicle control system includes a vehicle control apparatus that controls in-vehicle devices; and an electronic key and a portable device (smartphone) which are carried by a user. The portable device stores an in-vehicle device to be activated before the user gets in a vehicle among the in-vehicle devices, as personal setting data set by the user. When the portable device performs communication with the electronic key and establishes the communication, the portable device transmits the personal setting data to the electronic key. The electronic key transmits the personal setting data received from the portable device, to the vehicle control apparatus. Based on the personal setting data transmitted from the electronic key, the vehicle control apparatus activates the in-vehicle device set in the personal setting data, before the user gets in the vehicle.

### CROSS-REFERENCE TO RELATED APPLICATION

This application is based on Japanese Patent Application No. 2016-041942 filed with the Japan Patent Office on Mar. 4, 2016, the entire contents of which are incorporated herein by reference.

### FIELD

The disclosure relates to a vehicle control system that controls an operation of a vehicle by performing communication between a control apparatus included in the vehicle and an electronic key carried by a user.

### BACKGROUND

In-vehicle devices which are driven by ACC (accessory) power, such as a car navigation apparatus (hereinafter, referred to as “car navigation”), an air conditioning apparatus (hereinafter, referred to as “air conditioner”), lighting, and a cigarette lighter socket, are mounted on a vehicle. Conventionally, it is a common practice that these in-vehicle devices are activated by user operations after a user gets in the vehicle. However, in recent years, there has appeared a vehicle control system of a pre-activation scheme that allows in-vehicle devices to be activated before the user gets in the vehicle.

In this system, for example, when the user outside the vehicle performs an operation of unlocking doors using an electronic key, ACC power of the vehicle is applied, by which predetermined in-vehicle devices are automatically activated. Hence, at the point in time when the user gets in the vehicle and is seated, for example, the car navigation has already been activated or the vehicle has started to be cooled down by the air conditioner, and thus, user convenience improves. In addition, ACC power is supplied only to in-vehicle devices to be activated in advance, by which wasteful power consumption is suppressed.

JP 2010-202023 A discloses a vehicle power supply system in which according to operations performed on operating switches which are provided to accessory system loads, ignition system loads, and a start system load, respectively, power is supplied only to loads corresponding to the operated switches from a battery.

JP 2012-192754 A discloses an in-vehicle device control apparatus in which, when a window opening and closing switch is turned on, power from a battery is supplied to a window opening and closing control circuit, and when a radio power switch is turned on, power from the battery is supplied to a radio control circuit, by which power to a plurality of in-vehicle devices is individually controlled, reducing the power consumption of in-vehicle devices that are not in use.

In the conventional vehicle control system of a pre-activation scheme, in-vehicle devices that are objects to be activated in advance are predetermined, and thus, the user cannot arbitrarily select in-vehicle devices he/she wants to activate in advance.

### SUMMARY

An object of the disclosure is to provide a vehicle control system that allows a user to arbitrarily set in-vehicle devices he/she wants to activate in advance, and that is capable of ensuring safety in terms of security.

A vehicle control system according to one or more embodiments of the disclosure includes: a vehicle control apparatus mounted on a vehicle and configured to control in-vehicle devices included in the vehicle; an electronic key carried by a user and configured to perform communication with the vehicle control apparatus; and a portable device carried by the user and configured to perform communication with the electronic key. The portable device stores an in-vehicle device to be activated before the user gets in the vehicle among the in-vehicle devices, as personal setting data set by the user. When the portable device performs communication with the electronic key and establishes the communication, the portable device transmits the personal setting data to the electronic key. The electronic key transmits the personal setting data received from the portable device, to the vehicle control apparatus. Based on the personal setting data transmitted from the electronic key, the vehicle control apparatus activates the in-vehicle device set in the personal setting data, before the user gets in the vehicle.

With the vehicle control system, by registering in advance an in-vehicle device the user wants to activate in advance on the portable device as personal setting data, when communication is established between the electronic key and the portable device before the user gets in the vehicle, the personal setting data is transmitted from the portable device to the electronic key. The personal setting data is further transmitted from the electronic key to the vehicle control apparatus, and before the user gets in the vehicle, the vehicle control apparatus activates the in-vehicle device which is an object to be activated in advance and which is set in the received personal setting data. Hence, the user can arbitrarily set an in-vehicle device he/she wants to activate in advance, using the portable device. In addition, upon the user getting in the vehicle, the user can activate a desired in-vehicle device in advance using the portable device, and thus, user convenience improves.

In addition, upon transmission and reception of personal setting data, since the electronic key is interposed between the vehicle control apparatus and the portable device, the electronic key serves as a gateway. Hence, even when the portable device is connected to the Internet, security performance on the vehicle side can be enhanced compared to a case in which personal setting data is directly transmitted and received between the portable device and the vehicle control apparatus.

In one or more embodiments of the disclosure, the electronic key may include a memory configured to temporarily store the personal setting data received from the portable device; determine, after storing the personal setting data in the memory, whether the user has an intention of getting in the vehicle, based on an operation performed on the electronic key or based on communication between the electronic key and the vehicle control apparatus; and transmit the personal setting data in the memory to the vehicle control apparatus when it is determined that the user has an intention of getting in the vehicle.

In one or more embodiments of the disclosure, when a keyless entry operation is performed on the electronic key, or when the electronic key receives a response request signal for passive entry or for welcome entry from the vehicle control apparatus, or when the electronic key receives a signal transmitted from the vehicle control apparatus when a door of the vehicle is opened, the electronic key may determine that the user has an intention of getting in the vehicle.

In one or more embodiments of the disclosure, the electronic key may add the personal setting data to a signal for unlocking a door and transmit the signal for unlocking a door to the vehicle control apparatus.

In one or more embodiments of the disclosure, the signal for unlocking a door may be a remote control signal to be transmitted when a keyless entry operation is performed on the electronic key.

In one or more embodiments of the disclosure, the signal for unlocking a door may be a response signal for passive entry or for welcome entry, the response signal being returned in response to a response request signal transmitted from the vehicle control apparatus.

In one or more embodiments of the disclosure, the vehicle control apparatus may determine whether the electronic key is in the vehicle, when a door of the vehicle is closed and locked, and when the vehicle control apparatus determines that the electronic key is not in the vehicle, the vehicle control apparatus may bring the in-vehicle device that is activated before the user gets in the vehicle back to its original state.

In one or more embodiments of the disclosure, the portable device may be a smartphone that performs near-field wireless communication with the electronic key. Then, communication between the smartphone and the electronic key may be established by performing pairing between the smartphone and the electronic key.

According to one or more embodiments of the disclosure, a vehicle control system can be provided that allows a user to arbitrarily set in-vehicle devices he/she wants to activate in advance, and that is capable of ensuring safety in terms of security.

### BRIEF DESCRIPTION OF THE DRAWINGS

FIGS. 1A and 1B are schematic diagrams of a vehicle control system according to one or more embodiments of the disclosure;

FIG. 2 is a block diagram of the vehicle control system according to one or more embodiments of the disclosure;

FIG. 3 is a flowchart showing procedural steps for registration of personal setting data;

FIG. 4A is a diagram showing an initial screen of a portable device;

FIG. 4B is a diagram showing a selection screen of the portable device;

FIG. 40 is a diagram showing a guide screen of the portable device;

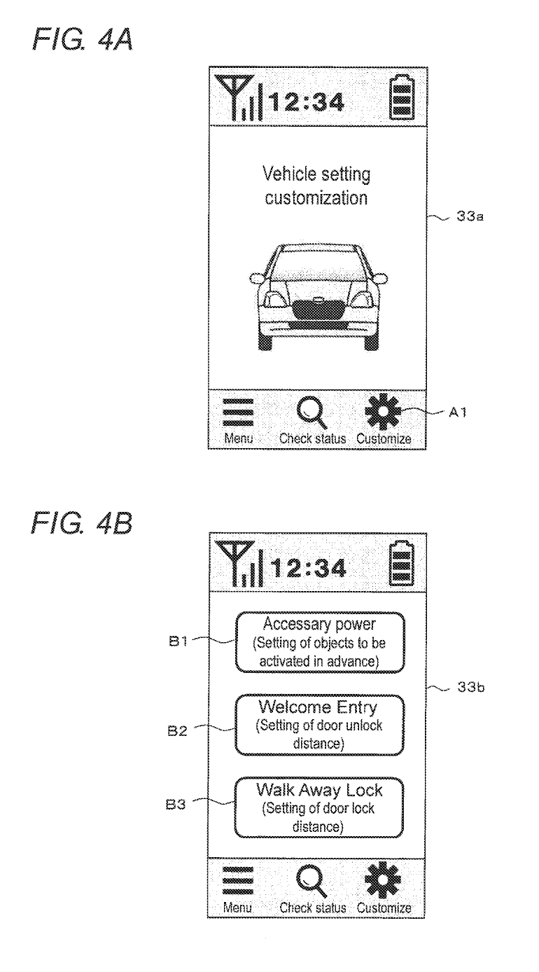

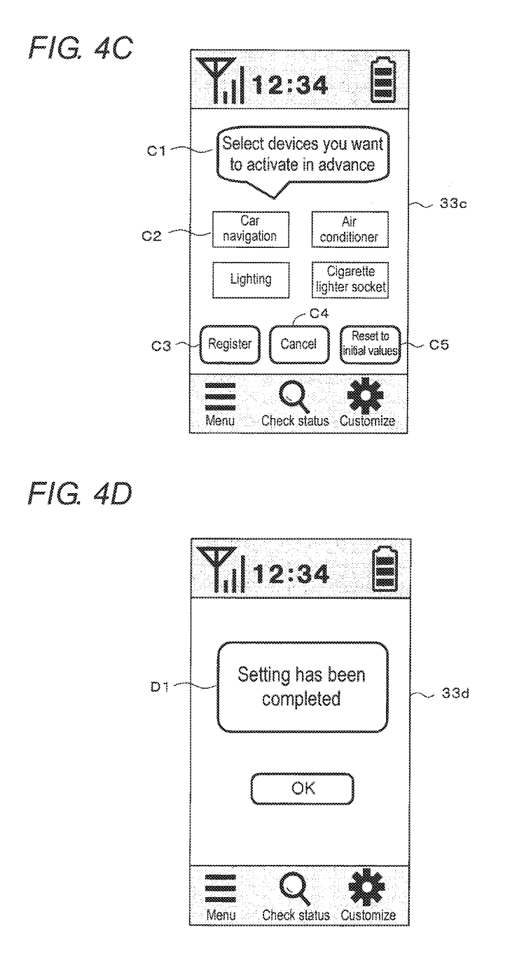

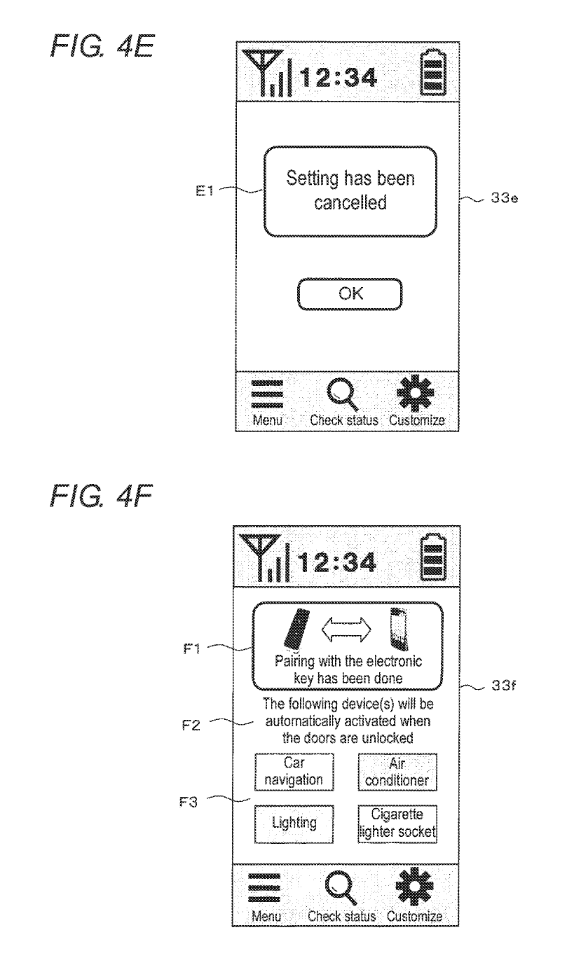

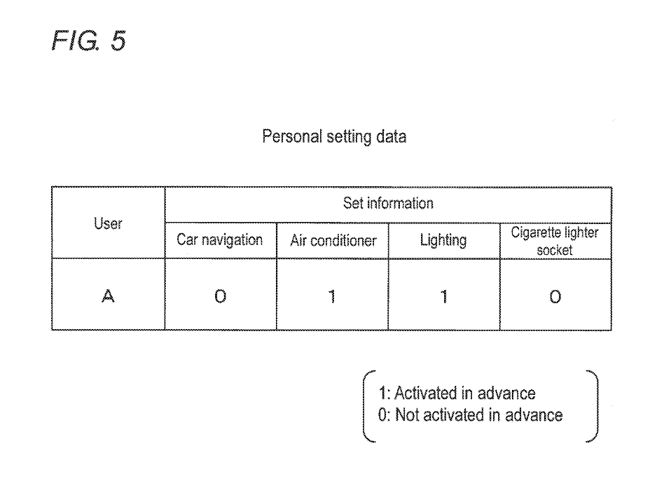

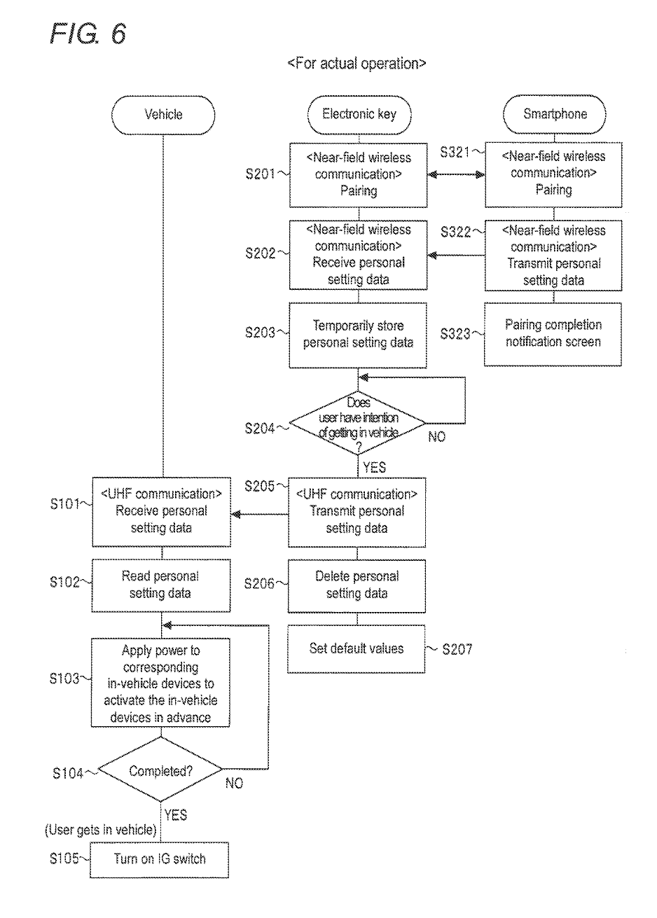

FIG. 4D is a diagram showing a setting completion notification screen of the portable device;

FIG. 4E is a diagram showing a setting cancellation notification screen of the portable device;

FIG. 4F is a diagram showing a pairing completion notification screen of the portable device;

FIG. 5 is a diagram showing an example of personal setting data; and

FIG. 6 is a flowchart showing procedural steps for actual operation.

### DETAILED DESCRIPTION

Embodiments of the disclosure will be described with reference to the drawings. In the drawings, the identical or equivalent component is designated by the identical numeral. In embodiments of the disclosure, numerous specific details are set forth in order to provide a more through understanding of the invention. However, it will be apparent to one of ordinary skill in the art that the invention may be practiced without these specific details. In other instances, well-known features have not been described in detail to avoid obscuring the invention. Hereinbelow, an example in which the disclosure is applied to an electric car will be described.

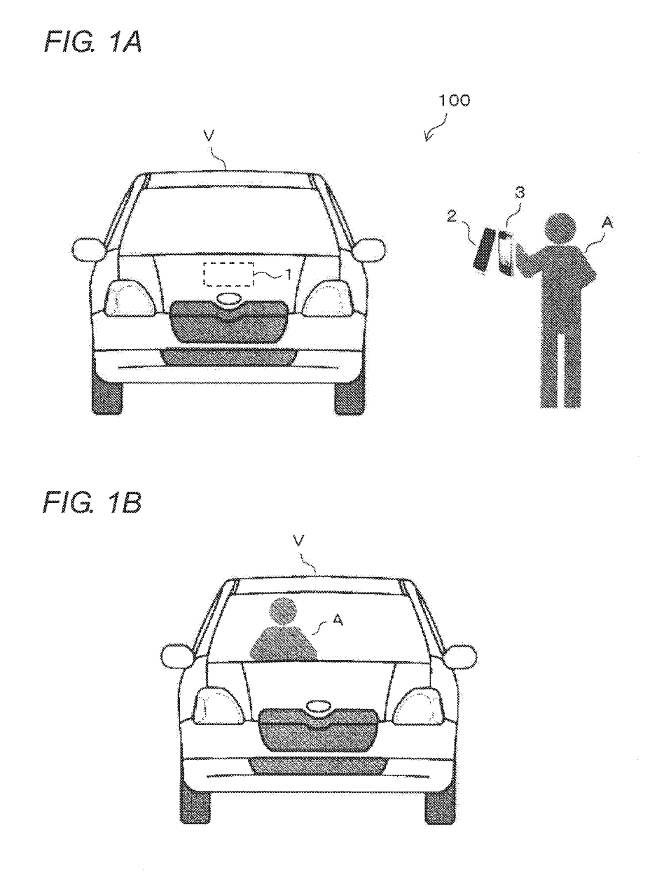

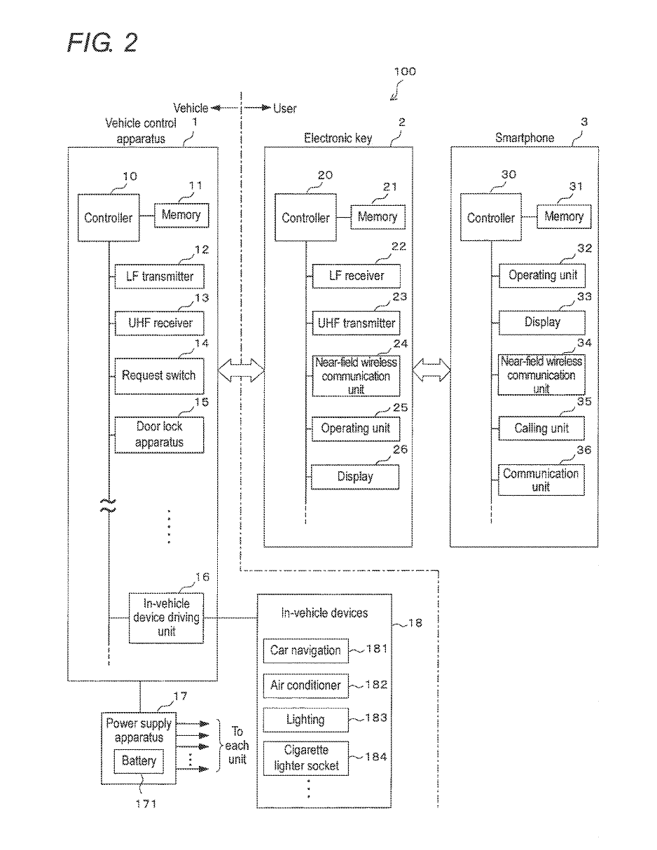

First, a configuration of a vehicle control system will be described with reference to FIGS. 1A, 1B, and 2.

As shown in FIGS. 1A and 1B, a vehicle control system 100 includes a vehicle control apparatus 1 mounted on a vehicle V; an electronic key 2 that performs wireless communication with the vehicle control apparatus 1; and a smartphone 3 that performs wireless communication with the electronic key 2. A user A carries the electronic key 2 and the smartphone 3. The user A activates, before getting in the vehicle V, a predetermined in-vehicle device mounted on the vehicle V, using the electronic key 2 and the smartphone 3, a detail of which will be described later. A summary is as follows.

The user A selects an in-vehicle device he/she wants to activate in advance among in-vehicle devices displayed on a screen, by operating the smartphone 3 and registers the selected in-vehicle device in advance on the smartphone 3 as personal setting data. When pairing is performed between the electronic key 2 and the smartphone 3 before the user A gets in the vehicle V (FIG. 1A) the personal setting data on the smartphone 3 is downloaded to the electronic key 2 and temporarily stored on the electronic key 2. Thereafter, when, for example, a keyless entry operation is performed on the electronic key 2, the electronic key 2 includes the personal setting data in a signal for unlocking doors and transmits the signal for unlocking doors to the vehicle control apparatus 1. The vehicle control apparatus 1 activates, before the user A gets in the vehicle V, the in-vehicle device set in the received personal setting data. In a state in which the user A has got in the vehicle V (FIG. 1B), the in-vehicle device (e.g., an air conditioner) set on the smartphone 3 is already in operation.

Here, the smartphone 3 is an example of a “portable device” according to one or more embodiments of the disclosure.

FIG. 2 shows specific configurations of the vehicle control apparatus 1, the electronic key 2, and the smartphone 3, each of which will be described in detail below.

The vehicle control apparatus 1 includes a controller 10, a memory 11, an LF (Low Frequency) transmitter 12, a UHF (Ultra High Frequency) receiver 13, a request switch 14, a door lock apparatus 15, and an in-vehicle device driving unit 16. Although the vehicle control apparatus 1 also includes various other types of blocks, they are not directly related to the disclosure and thus are not shown. Note that the vehicle control system 100 of FIG. 2 is not only a keyless entry system that performs locking or unlocking of doors based on an operation performed on the electronic key 2, but also a passive entry system that performs locking or unlocking of doors by performing communication between the vehicle control apparatus 1 and the electronic key 2 when the user has approached or touched a door knob.

The controller 10 includes a CPU and controls the operation of the vehicle control apparatus 1. The memory 11 includes memories such as a ROM and a RAM. The LF transmitter 12 intermittently transmits, in a predetermined cycle, an LF signal for checking the presence of the electronic key 2. The UHF receiver 13 receives data (described later) which is transmitted from the electronic key 2. The request switch 14 forms a passive entry system, together with the electronic key 2. The request switch 14 is provided near the door knob and detects a user's approach or touch. The door lock apparatus 15 includes, for example, a lock mechanism that locks and unlocks vehicle doors; and a drive circuit that allows the lock mechanism to operate.

The in-vehicle device driving unit 16 includes, for example, a drive circuit that drives in-vehicle devices 18 included in the vehicle; and a control circuit that controls the drive circuit. The in-vehicle devices 18 include accessory system loads such as a car navigation 181, an air conditioner 182, lighting 183, and a cigarette lighter socket 184. The in-vehicle devices 18 also include an audio apparatus and other devices in addition to the above-described ones.

A power supply apparatus 17 including a battery 171 is mounted on the vehicle, and electric power from the battery 171 is supplied, as power, to the vehicle control apparatus 1, the in-vehicle devices 18, and other blocks (not shown). The vehicle control apparatus 1 controls the power supply from the power supply apparatus 17 to each unit.

The electronic key 2 includes a controller 20, a memory 21, an LF receiver 22, a UHF transmitter 23, a near-field wireless communication unit 24, an operating unit 25, and a display 26. Although the electronic key 2 also includes other blocks, they are not directly related to the disclosure and thus are not shown.

The controller 20 includes a CPU and controls the operation of the electronic key 2. The memory 21 includes memories such as a ROM and a RAM. The LF receiver 22 receives the aforementioned LF signal transmitted from the LF transmitter 12 of the vehicle control apparatus 1. The UHF transmitter 23 transmits data (described later) to the vehicle control apparatus 1 by UHF communication. The near-field wireless communication unit 24 includes a communication circuit for near-field wireless communication such as a wireless LAN or Bluetooth (registered trademark). The operating unit 25 includes a plurality of operating buttons provided to a main body of the electronic key 2. The display 26 includes a plurality of LEDs provided to the main body of the electronic key 2.

The smartphone 3 includes a controller 30, a memory 31, an operating unit 32, a display 33, a near-field wireless communication unit 34, a calling unit 35, and a communication unit 36. Although the smartphone 3 also includes various other types of blocks, they are not directly related to the disclosure and thus are not shown.

The controller 30 includes a CPU and controls the operation of the smartphone 3. The memory 31 includes memories such as a ROM and a RAM. The operating unit 32 includes operating buttons provided to a main body of the smartphone 3 and operating buttons displayed on the display 33. The display 33 includes, for example, a liquid crystal panel provided to the main body of the smartphone 3; and a drive circuit for the liquid crystal panel. The near-field wireless communication unit 34 includes the same communication circuit as the near-field wireless communication unit 24 of the electronic key 2. The calling unit 35 includes a speaker, a microphone, an audio circuit, and the like. The communication unit 36 includes a communication circuit that is connected to an Internet line to perform communication with a server, etc.

The memory 31 of the smartphone 3 stores, as shown in FIG. 5, personal setting data including set information of the in-vehicle devices 18. The set information is information indicating which ones of the car navigation, the air conditioner, the lighting, and the cigarette lighter socket are to be set as objects to be activated in advance, and “1” or “0” is recorded for each device. “1” indicates that the device is an object to be activated in advance and “0” indicates that the device is not an object to be activated in advance. In an example of FIG. 5, the air conditioner and the lighting are set as objects to be activated in advance.

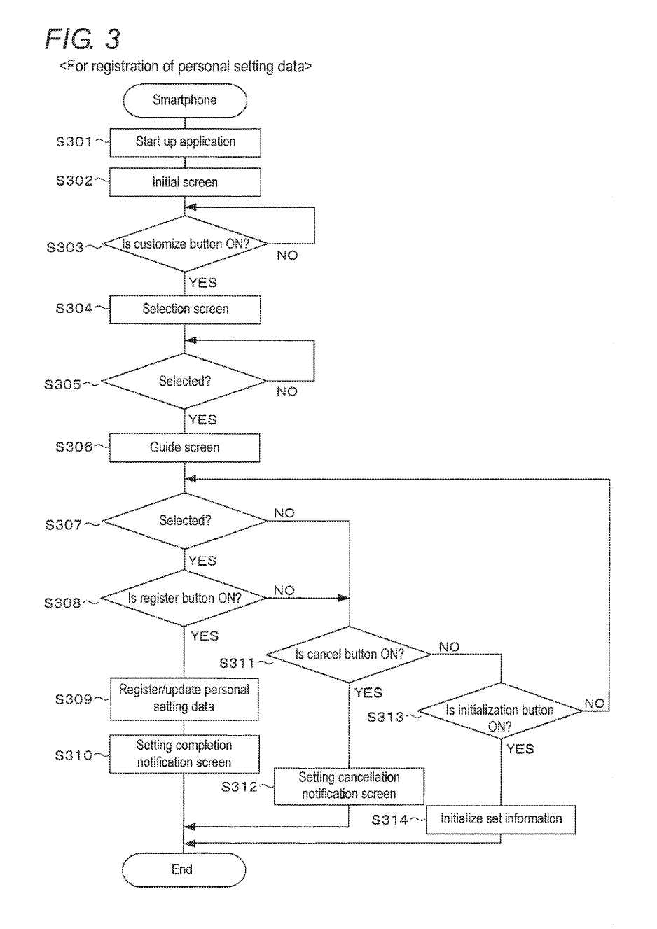

Next, procedural steps for a case of registering personal setting data in the vehicle control system 100 configured in the above-described manner will be described with reference to a flowchart of FIG. 3. Registration of personal setting data is performed on the smartphone 3.

The user first starts up a predetermined application by operating the smartphone 3 (step S301). By doing so, the display 33 of the smartphone 3 displays an initial screen 33a such as that shown in FIG. 4A (step S302). Subsequently, when the user presses a customize button A1 displayed on the initial screen 33a (step S303), the screen on the display 33 changes to a selection screen 33b such as that shown in FIG. 4B (step S304). The selection screen 33b displays buttons 81 to 83 for selecting a customization object.

When the user selects a customization object by pressing the accessory power button 81 for setting objects to be activated in advance on the selection screen 33b (step S305), the screen on the display 33 changes to a guide screen 33c such as that shown in FIG. 4C (step S306). The guide screen 33c displays a message C1 prompting the user to select in-vehicle devices he/she wants to activate in advance; in-vehicle device menu buttons C2; a register button C3; a cancel button C4; and an initialization button C5.

The user presses and selects in-vehicle device buttons he/she wants to activate in advance from among the in-vehicle device menu buttons C2 (step S307), and subsequently presses the register button C3 (step S308). By doing so, the selected in-vehicle devices are stored in the memory 31 and registered as personal setting data (step S309). For example, when the air conditioner and the lighting are selected using corresponding in-vehicle device menu buttons C2, as shown in FIG. 5, “1” is recorded for the air conditioner and the lighting, and “0” is recorded for the car navigation and the cigarette lighter socket which have not been selected. Note that when personal setting data is already registered in the memory 31, in the process at step S309 the personal setting data is updated. In this case, the old personal setting data is overwritten with the new personal setting data.

When the registration (or update) of the personal setting data is completed, the screen on the display 33 changes to a setting completion notification screen 33d such as that shown in FIG. 4D (step S310). The screen displays a message D1 notifying that the setting of in-vehicle devices the user wants to activate in advance has been completed.

On the other hand, when the cancel button C4 is pressed after selecting in-vehicle devices at step S307 (step S311), the screen on the display 33 changes to a setting cancellation notification screen 33e such as that shown in FIG. 4E (step S312). The screen displays a message E1 notifying that the setting of in-vehicle devices the user wants to activate in advance has been cancelled.

When the initialization button C5 is pressed after selecting in-vehicle devices at step S307 (step S313), the set information in personal setting data is reset to factory settings (step S314).

Next, procedural steps for actual operation performed after registration of personal setting data will be described with reference to a flowchart of FIG. 6. A condition for actual operation is that the user carries both the electronic key 2 and the smartphone 3.

The user first performs pairing between the electronic key 2 and the smartphone 3 before getting in the vehicle V (steps S201 and S321). The pairing is performed between the near-field wireless communication unit 24 of the electronic key 2 and the near-field wireless communication unit 34 of the smartphone 3, according to publicly known procedural steps.

When the pairing is performed normally and communication is established between the electronic key 2 and the smartphone 3, the smartphone 3 transmits the personal setting data (FIG. 5) stored in the memory 31 from the near-field wireless communication unit 34 to the electronic key 2 (step S322).

Subsequently, the display 33 of the smartphone 3 displays a pairing completion notification screen 33f such as that shown in FIG. 4F (step S323). The screen displays a message F1 notifying that the pairing has been completed; a message F2 informing the user about the activation of in-vehicle devices in advance; and a menu F3 that highlights in-vehicle devices that are to be activated in advance (here, the air conditioner and the lighting). The pairing completion notification screen 33f is automatically turned off after the passage of a certain period of time.

When the electronic key 2 receives, by the near-field wireless communication unit 24, the personal setting data transmitted from the smartphone 3 (step S202), the electronic key 2 saves and temporarily stores the personal setting data in the memory 21 (step S203). Thereafter, the electronic key 2 determines whether the user has an intention of getting in the vehicle V, based on an operation performed on the electronic key 2 or based on communication between the electronic key 2 and the vehicle control apparatus 1 (step S204). For example, when a keyless entry operation is performed on the operating unit 25 of the electronic key 2, it is determined that the user has an intention of getting in the vehicle V. In addition to that, when the electronic key 2 receives a response request signal (LF signal) which is transmitted from the vehicle control apparatus 1 when the request switch 14 detects the user in passive entry, too, it is determined that the user has an intention of getting in the vehicle V.

If it is determined that the user has an intention of getting in the vehicle V, the electronic key 2 adds the personal setting data stored in the memory 21 at step S203 to a signal for unlocking doors, and transmits the signal for unlocking doors, as a UHF signal, from the UHF transmitter 23 to the vehicle control apparatus 1 (step S205). For example, in the case of keyless entry, the signal for unlocking doors is a remote control signal which is transmitted in response to an operation performed on the electronic key 2, and in the case of passive entry, the signal for unlocking doors is a response signal which is returned in response to a response request signal transmitted from the vehicle control apparatus 1. Thereafter, the electronic key 2 deletes the personal setting data in the memory 21 (step S206) and sets default values of the set information in the memory 21 (step S207).

In the vehicle control apparatus 1, when the UHF receiver 13 receives the signal transmitted from the electronic key 2 (step S101), the controller 10 reads the personal setting data included in the signal (step S102). Then, based on the personal setting data, power is applied to corresponding in-vehicle devices 18 to activate the in-vehicle devices 18 in advance (step S103).

Specifically, the controller 10 identifies in-vehicle devices for which is recorded, i.e., in-vehicle devices that are objects to be activated in advance, by referring to the set information included in the personal setting data (FIG. 5), and controls the power supply apparatus 17 such that power from the battery 171 is supplied to the in-vehicle devices. By this, power is applied to in-vehicle devices that need to be activated in advance, and the in-vehicle devices are activated before the user gets in the vehicle V. Note that in order to suppress power consumption, power supply from the battery 171 is performed only to in-vehicle devices that are to be activated in advance, and power is not supplied to in-vehicle devices that are not objects to be activated in advance. In the example of FIG. 5, power is supplied from the battery 171 to the air conditioner 182 and the lighting 183 which are objects to be activated in advance among the in-vehicle devices 18, and the air conditioner 182 and the lighting 183 are activated in advance. Power from the battery 171 is not supplied to the car navigation 181 and the cigarette lighter socket 184 which are not objects to be activated in advance.

After the completion of activation of the in-vehicle devices in advance (step S104), the user gets in the vehicle V and turns on an ignition switch (step S105), by which an engine starts, transitioning to a normal driving state. At the point in time when the user gets in the vehicle V and is seated, the in-vehicle devices having been activated in advance are already in operation and thus the air conditioner 182 is blowing air and the lighting 183 is turned on.

According to an illustrative embodiment, of the in-vehicle devices 18, devices the user wants to activate in advance are registered in advance on the smartphone 3 as personal setting data, and the user performs pairing between the electronic key 2 and the smartphone 3 before getting in the vehicle V, to transmit the personal setting data from the smartphone 3 to the electronic key 2. Thereafter, when the user's intention of getting in the vehicle V is confirmed by, for example, an operation performed on the electronic key 2, a signal including the personal setting data is transmitted from the electronic key 2 to the vehicle control apparatus 1. Based on the received personal setting data, the vehicle control apparatus 1 applies power to in-vehicle devices that are objects to be activated in advance, to activate the in-vehicle devices. Hence, the user can arbitrarily set in-vehicle devices he/she wants to activate in advance, using the smartphone 3. In addition, upon the user getting in the vehicle V, the user can activate desired in-vehicle devices in advance using the smartphone 3, and thus, user convenience improves.

In addition, upon transmission and reception of personal setting data, since the electronic key 2 is interposed between the vehicle control apparatus 1 and the smartphone 3, the electronic key 2 serves as a gateway. Hence, even when the smartphone 3 is connected to the Internet, etc., security performance on the vehicle side can be enhanced compared to a case in which personal setting data is directly transmitted and received between the smartphone 3 and the vehicle control apparatus 1.

Furthermore, according to an illustrative embodiment, after the electronic key 2 transmits personal setting data in the memory 21 to the vehicle control apparatus 1, the electronic key 2 deletes the personal setting data in the memory 21. Thus, the capacity of memories forming the memory 21 does not need to be large.

One or more embodiments of the disclosure can adopt various embodiments such as those shown below in addition to the above-described embodiment.

A determination as to whether the electronic key 2 is in the vehicle V may be made when a door of the vehicle V is closed and locked. If it is determined that the electronic key 2 is not in the vehicle V, it may be determined that the user has changed his/her mind and got out of the vehicle V, and thus, in-vehicle devices having been activated in advance may be brought back to their original states. The determination as to whether the electronic key 2 is in the vehicle V is made by comparing the strength of an LF signal transmitted from the vehicle control apparatus 1 and received by the electronic key 2 with a predetermined threshold value. When the signal strength is greater than or equal to the threshold value, it is determined that the electronic key 2 is in the vehicle V.

The vehicle control apparatus 1 may store, in the memory 11, personal setting data received from the electronic key 2 (step S101 of FIG. 6). This storage state is maintained until the next time the vehicle control apparatus 1 receives personal setting data from the electronic key 2. By doing so, for example, even when the power to the smartphone 3 is turned off and thus pairing has not been performed between the electronic key 2 and the smartphone 3, or when personal setting data on the smartphone 3 is deleted, since the last personal setting data is stored in the memory 11, activation of in-vehicle devices in advance can be performed using the electronic key 2 based on the personal setting data in the memory 11. In this case, when the vehicle V is owned by a single user, the personal setting data in the memory 11 is validated, and when the vehicle V is shared by a plurality of users such as car sharing, the personal setting data in the memory 11 is invalidated.

In an illustrative embodiment, when a keyless entry operation is performed on the electronic key 2 or when the electronic key 2 receives a response request signal transmitted from the vehicle control apparatus 1 in passive entry, it is determined that the user has an intention of getting in the vehicle V; however, the disclosure is not limited thereto. For example, in welcome entry where unlocking of the doors, the turning on of the lighting, etc., are automatically performed by the user approaching the vehicle V, when the electronic key 2 receives a response request signal transmitted from the vehicle side, it may be determined that the user has an intention of getting in the vehicle V. In this case, as with the passive entry, personal setting data is added to a response signal for unlocking doors which is returned in response to a response request signal. In addition, when a door of the vehicle V is opened by the user, an LF signal that requests personal setting data may be transmitted from the vehicle control apparatus 1 to the electronic key 2, and when the electronic key 2 receives the LF signal, it may be determined that the user has an intention of getting in the vehicle V.

An illustrative embodiment shows an example in which, when it is determined that the user has an intention of getting in the vehicle V, personal setting data is added to a remote control signal for keyless entry or to a response signal for passive entry or welcome entry and transmitted; however, the personal setting data may be transmitted separately from the remote control signal or the response signal. For example, when it is determined that the user has an intention of getting in the vehicle V, a remote control signal or a response signal may be transmitted without adding personal setting data thereto, and thereafter, when an LF signal that requests personal setting data is received from the vehicle control apparatus 1, personal setting data may be transmitted to the vehicle control apparatus 1 using a UHF signal. Alternatively, when it is determined that the user has an intention of getting in the vehicle V, a remote control signal or a response signal may be transmitted first, followed by personal setting data.

In an illustrative embodiment, the electronic key 2 or the vehicle control apparatus 1 determines whether the user has an intention of getting in the vehicle V and when it is confirmed that the user has an intention of getting in the vehicle V, the vehicle control apparatus 1 activates predetermined in-vehicle devices 18 in advance based on personal setting data; however, the disclosure is not limited thereto. For example, at the point in time when a certain period of time has elapsed from the completion of pairing between the electronic key 2 and the smartphone 3, the vehicle control apparatus 1 may activate predetermined in-vehicle devices 18 in advance. Alternatively, the vehicle control apparatus 1 may activate predetermined in-vehicle devices 18 in advance, based on the fact that a specific operation for activation in advance is performed on the electronic key 2 or on the smartphone 3 after the completion of pairing.

Although an illustrative embodiment shows the car navigation 181, the air conditioner 182, the lighting 183, and the cigarette lighter socket 184 as an example of the in-vehicle devices 18 which are objects to be activated in advance, in addition to them, for example, an audio apparatus may serve as an object to be activated in advance.

Although an illustrative embodiment shows the smartphone 3 as an example of a portable device, instead of a smartphone, any other mobile phone, portable tablet, etc., may be used as a portable device.

The system according to one or more embodiments of the disclosure is applicable not only to the aforementioned car sharing, but also to, for example, a case of using a company-owned vehicle by a plurality of employees or a case of using a single vehicle by family members. In these cases, in-vehicle devices customized to each individual's needs can be activated in advance, according to set information which is set on each individual's portable device.

While the invention has been described with reference to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A vehicle control system comprising:
a vehicle control apparatus mounted on a vehicle and configured to control in-vehicle devices included in the vehicle;
an electronic key carried by a user and configured to perform communication with the vehicle control apparatus; and
a portable device carried by the user and configured to perform communication with the electronic key,
wherein the portable device stores an in-vehicle device to be activated before the user gets in the vehicle among the in-vehicle devices, as personal setting data set by the user,
wherein when the portable device performs communication with the electronic key and establishes the communication, the portable device transmits the personal setting data to the electronic key,
wherein the electronic key transmits the personal setting data received from the portable device, to the vehicle control apparatus, and
wherein based on the personal setting data transmitted from the electronic key, the vehicle control apparatus activates the in-vehicle device set in the personal setting data, before the user gets in the vehicle.

2. The vehicle control system according to claim 1,
wherein the electronic key:
includes a memory configured to temporarily store the personal setting data received from the portable device;
determines, after storing the personal setting data in the memory, whether the user has an intention of getting in the vehicle, based on an operation performed on the electronic key or based on communication between the electronic key and the vehicle control apparatus; and
transmits the personal setting data in the memory to the vehicle control apparatus when it is determined that the user has an intention of getting in the vehicle.

3. The vehicle control system according to claim 2,
wherein when a keyless entry operation is performed on the electronic key, or when the electronic key receives a response request signal for passive entry or for welcome entry from the vehicle control apparatus, or when the electronic key receives a signal transmitted from the vehicle control apparatus when a door of the vehicle is opened, the electronic key determines that the user has an intention of getting in the vehicle.

4. The vehicle control system according to claim 2,
wherein the electronic key adds the personal setting data to a signal for unlocking a door and transmits the signal for unlocking a door to the vehicle control apparatus.

5. The vehicle control system according to claim 4,
wherein the signal for unlocking a door is a remote control signal transmitted when a keyless entry operation is performed on the electronic key.

6. The vehicle control system according to claim 4,
wherein the signal for unlocking a door is a response signal for passive entry or for welcome entry, the response signal being returned in response to a response request signal transmitted from the vehicle control apparatus.

7. The vehicle control system according to claim 1,
wherein the vehicle control apparatus determines whether the electronic key is in the vehicle, when a door of the vehicle is closed and locked, and when the vehicle control apparatus determines that the electronic key is not in the vehicle, the vehicle control apparatus brings the in-vehicle device that is activated before the user gets in the vehicle back to its original state.

8. The vehicle control system according to claim 1,
wherein the portable device is a smartphone that performs near-field wireless communication with the electronic key, and
wherein communication between the smartphone and the electronic key is established by performing pairing between the smartphone and the electronic key.
